(19) United States
(12) Patent Application Publication
(10) Pub. No.: US 2016/0164945 A1
(43) Pub. Date: Jun. 9, 2016

(54) Method Of Service Capability Discovery Based On Subscriptions For Service Notifications

(71) Applicant: Futurewei Technologies, Inc., Plano, TX (US)

(72) Inventors: Xinmin Ding, San Jose, CA (US); Huipeng Ren, Shenzhen (CN)

(21) Appl. No.: 14/560,124

(22) Filed: Dec. 4, 2014

(51) Int. Cl. H04L 29/08

(52) U.S. Cl. CPC H04L 67/02; H04L 67/32

(57) ABSTRACT

A method of capability discovery notification is provided. The method includes receiving, from a representational state transfer (REST) client, a subscription for service notifications. The service capability of the REST client, which is based on the subscription for service notifications received, is stored in memory. A request for the service capability of the REST client is received from a network and the service capability of the REST client is retrieved from the memory based on the request received. A response to the request for the service capability of the REST client is sent to the network. The response includes the service capability of the REST client retrieved from the memory.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Representational state transfer (REST) is an abstraction of the architecture of the World Wide Web. More precisely, REST is an architectural style including a coordinated set of architectural constraints applied to components, connectors, and data elements within a distributed hypermedia system. REST ignores the details of component implementation and protocol syntax in order to focus on the roles of components, the constraints upon their interaction with other components, and their interpretation of significant data elements.

The REST architectural style may be applied to the development of web services as an alternative to other distributed-computing specifications such as, for example, Simple Object Access protocol (SOAP). One can characterize web services as “RESTful” if they conform to certain architectural constraints involving or relating to a client-server model, a stateless protocol, a web cache, a layered system, code on demand (optional), and a uniform interface.

In some circumstances, the REST architectural style may be applied to web application programming interfaces (APIs). Web APIs that adhere to the architectural constraints are called RESTful.

### SUMMARY

In one embodiment, the disclosure includes a method of capability discovery notification including receiving, from a representational state transfer (REST) client, a subscription for service notifications, storing a service capability of the REST client in memory, wherein the service capability of the REST client based on the subscription for service notifications received, receiving, from a network, a request for the service capability of the REST client, retrieving the service capability of the REST client from the memory based on the request received, and sending, to the network, a response to the request for the service capability of the REST client, wherein the response includes the service capability of the REST client retrieved from the memory.

In another embodiment, the disclosure includes a method of capability discovery notification. The method includes receiving, from a representational state transfer (REST) client, a first subscription for service notifications and a second subscription for service notifications, wherein the first subscription for service notifications is different than the second subscription for service notifications, storing a first service capability of the REST client and a second service capability of the REST client in memory, wherein the first service capability of the REST client and the second service capability of the REST client are based on the first and second service notifications received, and wherein the first service capability of the REST client is different than the second service capability of the REST client, receiving, from the representational state transfer (REST) client, an instruction to remove the first service capability of the REST client from the memory, removing the first service capability of the REST client from the memory based on the instruction received, receiving, from a network, a service capability request for the REST client, retrieving the second service capability of the REST client from the memory based on the service capability request received, and sending, to the network, a response to the service capability request for the REST client, the response including the second service capability of the REST client retrieved from the memory.

In yet another embodiment, the disclosure includes a service application server. The server includes a processor operably coupled to a memory and a service capability module stored in the memory that, when executed by the processor, is configured to receive, from a representational state transfer (REST) client, a plurality of subscriptions for service notifications, store service capabilities of the REST client in memory, wherein the service capabilities of the REST client are based on the plurality of subscriptions for service notifications received, receive, from the REST client, an instruction to remove at least one of the plurality of subscriptions for service notifications from the memory, update the memory based on the instruction such that the memory contains a current indication of the service capabilities of the REST client, and send, to a network, the current indication of the service capabilities of the REST client when a request for the service capabilities of the REST client is received from the network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a service discovery capability message sent in a representational state transfer (REST) system.

FIG. 2 is a schematic diagram of a subscription request message in a REST system.

FIG. 3 is a schematic diagram of a collision that may occur when an application programming interface (API) server has been informed that a client has a particular service, but no corresponding subscription has been established.

FIG. 4 is a protocol diagram of an embodiment of a method of capability discovery notification.

FIG. 5 is a protocol diagram of an embodiment of a method of capability discovery notification.

FIG. 6 is a schematic diagram of an embodiment of a computing device capable of facilitating the methods of FIGS. 4-5.

FIG. 7 is a flowchart of an embodiment of a capability discovery notification method.

FIG. 8 is a flowchart of an embodiment of a capability discovery notification method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for capability discovery based on subscriptions for service notifications in a REST system. As will be more fully explained below, the system and methods disclosed herein permit an application server to continually update and store in memory the current service capabilities of a REST client based on subscriptions received from the REST client. When the network of a target client makes a request for the service capabilities of the REST client, the application server is able to respond with a current indication of the service capabilities of the REST client. Because the service capabilities of the REST client are kept up-to-date based on the current subscriptions of the REST client, collisions occurring when the application server has been informed that the REST client has a particular service capability but no corresponding subscription has been established are prevented.

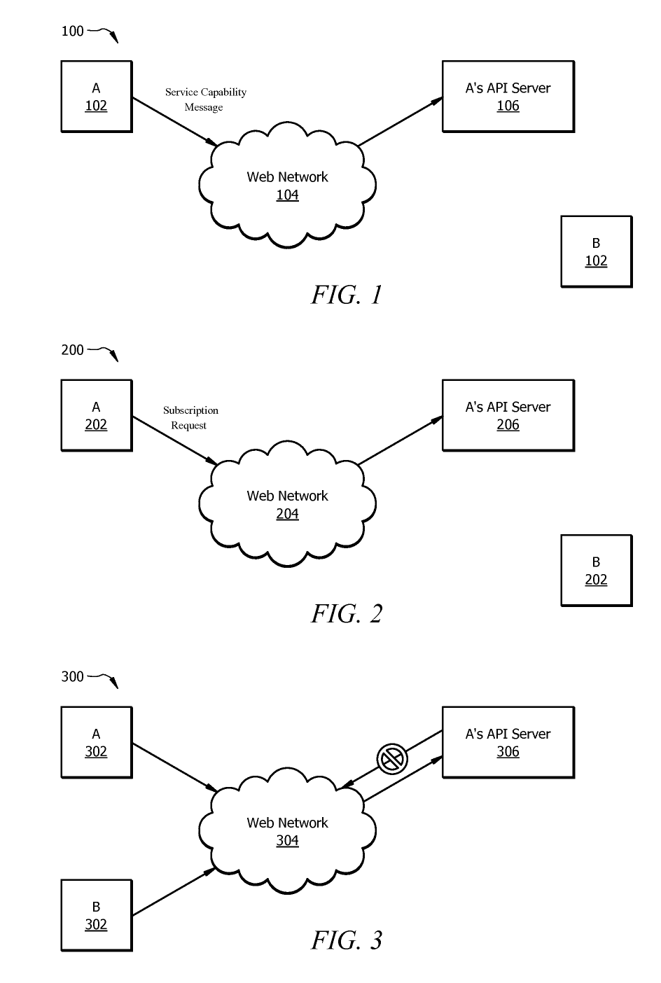

FIG. 1 is a schematic diagram of a REST system 100. The REST architecture and API are described in more detail in the RESTful Network API for Capability Discovery, Candidate Version 1.0, specification published Jul. 1, 2013, and the Enabler Release Definition for RESTful Network API for Capability Discovery, Candidate Version 1.0, specification published Jul. 1, 2013, both of which are incorporated herein by reference as if reproduced in their entirety.

As shown in FIG. 1, the REST system 100 includes one or more computing devices, which for convenience will be referred to herein as clients 102. In some embodiments, one or both of the clients 102 may be a personal computer (PC), a mobile device (e.g., smart phone, tablet computer, etc.). Each client 102 may include one or more APIs used to handle a web application. By way of example, the web application may be a web application used to make video calls (e.g., Microsoft Skype™) or to otherwise facilitate communication between the clients 102.

Each client 102 includes a browser (e.g., Mozilla Firefox®, Google Chrome®, Microsoft Internet Explorer®, or Apple Safari®). As well known in the art, a browser is a software application for retrieving, presenting, and traversing information resources on the World Wide Web. Some web browsers utilize a technology referred to a Web Real-Time Communications (WebRTC). WebRTC is an API drafted by the Worldwide Web Consortium (W3C) that supports browser-to-browser application for video-calling, video chat, peer-to-peer (P2P) file sharing, and the like, without requiring a plugin in the browser. If the browser of each client 102 includes support for WebRTC, the clients 102 may engage in browser-to-browser communications without the need for a plugin.

As shown in FIG. 1, one of the clients 102 is labeled client A and another of the clients is labeled client B. Client A possesses certain service capabilities. For example, client A may be configured for chat, video chat, file transfer, some other type of communication, or combinations thereof. Client B also possesses certain service capabilities. For example, client B may be configured for chat, video chat, file transfer, some other type of communication, or combinations thereof. In some circumstances, the service capability of client A and the service capability of client B are the same or similar. In other circumstances, the service capability of client A and the service capability of client B are different. Client A is configured to communicate with A's API server 106 though web network 104. A's API server 106 may be, for example, a WebRTC user network interface (UNI) server.

An API server may be informed of a corresponding client's service capabilities through a service capability message, which is described below in connection with FIG. 1. In order to create, update, delete, or query its service capabilities on A's API server 106, client A sends a service capability message (represented by the arrow) to A's API server 106. In some embodiments, the service capability message is in a Hypertext Transfer Protocol (HTTP) format. For example, the service capability message may be implemented using the HTTP operations GET, POST, and/or DELETE as described in the Internet Engineering Task Force (IETF) document, draft-ietf-httpbis-p2-semantics-26, published Feb. 6, 2014, and the Request for Comments (RFC) document, Hypertext Transfer Protocol (HTTP/1.1): Semantics and Content, RFC 7231, published June 2014, both of which are incorporated herein by reference as if reproduced in their entirety.

In response to the service capability message received from client A, A's API server 106 either creates a new record for client A's service capability, updates client A's service capability, deletes client A's service capability, or advises client A of client A's current service capability stored on A's API sever 106. As such, A's API server 106 is configured to maintain the service capability of client A, which may or may not be RESTful, and to report that service capability to any client (e.g., client A or client B) that makes a request for the service capability of client A. While not illustrated in FIG. 1, client B is configured to engage in the same type of communications with its own API server regarding the service capability of client B.

FIG. 2 is a schematic diagram of REST system 200. The REST system 200 includes one or more computing devices, which are referred to clients 202. The clients 202, A's API server 206, and the web network 204 are configured similar to the clients 102, A's API server 106, and the web network 104 in FIG. 1. When client A wants to engage in a particular type of communication (e.g., chat, file transfer), client A sends a subscription request (represented by the arrow) to A's API server 206. In some embodiments, the subscription request may be implemented using the chat protocols described in the RESTful Network API for Chat, Candidate Version 1.0, specification published May 13, 2013, which is incorporated herein by reference as if reproduced in its entirety.

In response to the subscription request received from client A, A's API server 206 establishes a channel for the particular type of communication requested by client A. If, for example, client A sent a video chat subscription request, A's API server 206 establishes the subscription for video chatting. If, for example, client A sent a file transfer subscription request, A's API server 206 establishes the subscription for file transfer. However, A's API server 206 is not informed of the service capability of client A until a service capability message is sent to A's API server 206 as described in connection with FIG. 1. In other words, A's API server 206 does not create, update, or delete the service capability of client A stored on A's API server in response to the subscription request.

Unfortunately, collisions may occur when an API server has been informed that its client has a particular service capability, but no corresponding subscription has been established. This scenario is illustrated in FIG. 3. FIG. 3 is a schematic diagram of REST system 300. The REST system 300 includes one or more computing devices, which are referred to clients 302. The clients 302, A's API server 306, and the web network 304 are configured similar to the clients 102, 202, A's API server 106, 206, and the web network 104, 204 in FIGS. 1-2.

In FIG. 3, client A sends a service capability message to A's API server 306. In response to the message, A's API server 306 is informed that client A is equipped for a particular service (e.g., video chat, file transfer, etc.). Prior to client A making a subscription request to establish a subscription (e.g., channel) to facilitate the particular service, client B sends an invite (e.g., a chat invite, a file transfer invite) to A's API server 306. Because client A has not established a subscription for the particular service yet, A's API server 306 is unable to send the invitation (as represented by the circle-backslash symbol) to client A. In other words, the chat invitation is rejected, which leads to a poor service experience.

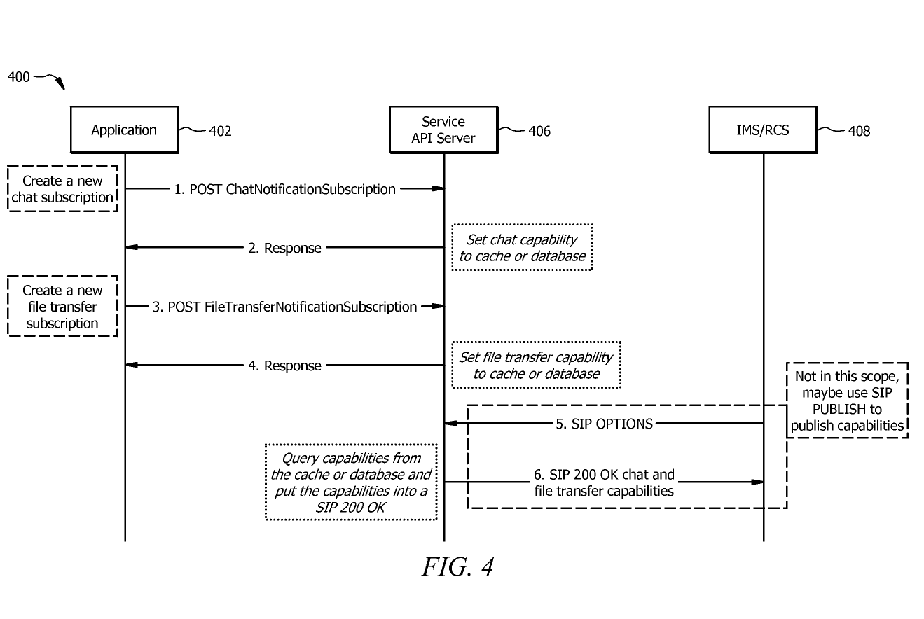

FIG. 4 is protocol diagram of an embodiment of a method 400 of capability discovery notification that solves the foregoing problems. The method 400 is illustrated in the context of a client 402, a service API server 406, and a network 408. In an embodiment, the network 408 is an Internet Protocol (IP) multimedia system/Rich Communications Services (IMS/RCS) network. The client 402 and the service API server 406 are configured similar to the clients 102, 202, 302 and the API server 106, 206, 306 in FIGS. 1-3.

As shown in FIG. 4, in order to initiate capability discovery notification, the client 402 (e.g., using an application) creates a new chat subscription by sending a subscription for service notifications to the service API server 406. In an embodiment, the subscription for service notifications is in the form of an HTTP POST message (e.g., POST ChatNotificationSubscription). In an embodiment, the subscription for service notifications is for standalone messaging, chat, group chat, video chat, file transfer, content sharing, social presence information, IP voice call, best effort video call, geolocation exchange, network based blacklist, and capability exchange based, etc. In an embodiment, the service is a service offered in connection with RCS.

After receipt of the subscription for service notifications from the client 402, the service API server 406 sends a response to the client 402 to advise the client 402 that the message was successfully received. In an embodiment, the response is a HTTP 201 Created response. The HTTP 201 Created response is described in RFC 7231. The service API server 406 stores a service capability of the client 402 in memory based on the subscription for service notifications that was received. For example, if the service API server 406 receives a subscription for chat from the client 402, the service API server 406 creates or updates a record stored in, for example, a cache or a database to indicate that client 402 is capable of participating in a chat. In an embodiment, the service capability of the client 402 includes one or more of standalone messaging, chat, group chat, video chat, file transfer, content sharing, social presence information, IP voice call, best effort video call, geolocation exchange, network based blacklist, and capability exchange based, etc. In an embodiment, the capability of the client 402 corresponds to a service offered in connection with RCS. Thus, the service API server 406 is informed of the service capability of the client 402 without the client having to send a separate service capability message to the service API server 406. Therefore, a single step procedure (e.g., sending the subscription) replaces the two-step procedure (e.g., sending both the service capability message and the subscription). The service capability message is eliminated, which simplifies the capability discovery process and reduces the messaging between the client 402 and the service API server 406.

Optionally, the client 402 also creates a new file transfer subscription by sending a subscription for service notifications to the service API server 406. In an embodiment, the subscription for service notifications is in the form of an HTTP POST message (e.g., POST FileTransferNotificationSubscription).

After receipt of the subscription for service notifications from the client 402, the service API server 406 sends a response to the client 402 to advise the client 402 that the message was successfully received. In an embodiment, the response is a HTTP 201 Created response. The service API server 406 stores a service capability of the client 402 in memory based on the subscription for service notifications that was received. For example, if the service API server 406 receives a subscription for file transfer from the client 402, the service API server 406 creates or updates a record to indicate that client 402 is capable of participating in a file transfer. Once again, the service API server 406 is informed of the service capability of the client 402 without the client having to send a separate service capability message to the service API server 406.

As shown in FIG. 4, the service API server 406 receives a request for the service capability of the client 402 from the network 408. The request may be in the form of a SIP OPTIONS request or a SIP PUBLISH request. The OPTIONS request and the PUBLISH request are described in more detail in the Internet Engineering Task Force (IETF) document, draft-ietf-sip-rfc2543bis-08.txt, published Feb. 21, 2002, and the Request for Comments (RFC) document, RFC 3261, published June 2002, both of which are incorporated herein by reference as if reproduced in their entirety. Although not illustrated in FIG. 4, the network 408 may receive the request from another client (e.g., mobile phone, tablet computer, etc.) in the form of a SIP OPTIONS request.

Upon receipt of the request for the service capability of the client 402 from the network 408, the service API server 406 is configured to parse the request. The service API server 406 then retrieves the service capability of the client 402 from the memory based on the request received. Once the service capability has been obtained from the memory, the service API server 406 sends a response to the request for the service capability of the client 402 to the network 408. The response includes the service capability, in this case chat and file transfer, of the client 402. In an embodiment, the response is in the form of a SIP OK message. The network 408 is then able to notify the requesting client of the service capability of the client 402.

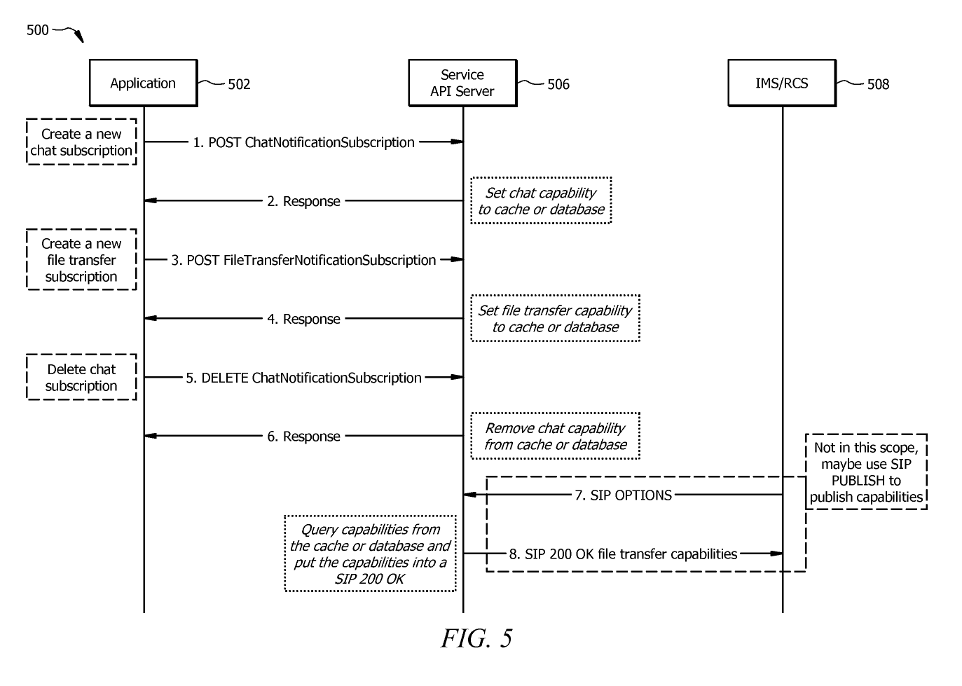

FIG. 5 is protocol diagram of an embodiment of another method 500 of capability discovery notification. The method 500 is illustrated in the context of a client 502, a service API server 506, and a network 508. The client 502 and the service API server 506 are configured similar to the clients 102, 202, 302, 402 and the API server 106, 206, 306, 406 in FIGS. 1-4. The network 508 is configured similar to the network 408 in FIG. 4.

As shown in FIG. 5, in order to initiate capability discovery notification, the client 502 (e.g., using an application) creates a new chat subscription by sending a subscription for service notifications to the service API server 506. In an embodiment, the subscription for service notifications is in the form of an HTTP POST message (e.g., POST ChatNotificationSubscription).

After receipt of the subscription for service notifications from the client 502, the service API server 506 sends a response to the client 502 to advise the client 502 that the message was successfully received. In an embodiment, the response is a HTTP 201 Created response.

The service API server 506 stores a service capability of the client 502 in memory based on the subscription for service notifications that was received. For example, if the service API server 506 receives a subscription for chat from the client 502, the service API server 506 creates or updates a record stored in, for example, a cache or a database to indicate that client 502 is capable of participating in a chat. Thus, the service API server 506 is informed of the service capability of the client 502 without the client having to send a separate service capability message to the service API server 506. Therefore, a single step procedure (e.g., sending the subscription) replaces the two-step procedure (e.g., sending both the service capability message and the subscription). The service capability message is eliminated, which simplifies the capability discovery process and reduces the messaging between the client 502 and the service API server 506.

The client 502 also creates a new file transfer subscription by sending a subscription for service notifications to the service API server 506. In an embodiment, the subscription for service notifications is in the form of an HTTP POST message (e.g., POST FileTransferNotificationSubscription).

After receipt of the subscription for service notifications from the client 502, the service API server 506 sends a response to the client 502 to advise the client 502 that the message was successfully received. In an embodiment, the response is a HTTP 201 Created response. The service API server 506 stores a service capability of the client 502 in memory based on the subscription for service notifications that was received. For example, if the service API server 506 receives a subscription for file transfer from the client 502, the service API server 506 creates or updates a record to indicate that client 502 is capable of participating in a file transfer. Once again, the API server 506 is informed of the service capability of the client 502 without the client having to send a separate service capability message to the service API server 506.

Unlike in the method 400 of FIG. 4, in the method 500 of FIG. 5 the client 502 sends a message to the service API server 506 to request that, for example, the chat subscription be deleted. In other words, the client 502 requests that one of the previously-established subscriptions be terminated. In an embodiment, the delete message is in the form of an HTTP DELETE message (e.g., DELETE ChatNotificationSubscription). After receipt of the delete message from the client 502, the service API server 506 sends a response to the client 502 to advise the client 502 that the message was successfully received. In an embodiment, the response is a 204 No Content response. The 204 No Content response is described in RFC 7231. The service API server 506 also removes the chat capability from the memory on the service API server 506. In other words, the capability of the client 502 is updated or modified based on the delete message to reflect the current capabilities of the client 502.

As shown in FIG. 5, the service API server 506 receives a request for the service capability of the client 502 from the network 508. The request may be in the form of a SIP OPTIONS request or a SIP PUBLISH request. Although not illustrated in FIG. 5, the network 508 may receive the request from another client (e.g., mobile phone, tablet computer, etc.) in the form of a SIP OPTIONS request.

Upon receipt of the request for the service capability of the client 502 from the network 508, the service API server 506 is configured to parse the request. The service API server 506 then retrieves the service capability of the client 502 from the memory based on the request received. Once the service capability has been obtained from the memory, the service API server 506 sends a response to the request for the service capability of the client 502 to the network 508. The response includes the service capability, in this case file transfer (but not chat, which was deleted), of the client 502. In an embodiment, the response is in the form of a SIP OK message. The network 508 is then able to notify the requesting client of the service capability of the client 502.

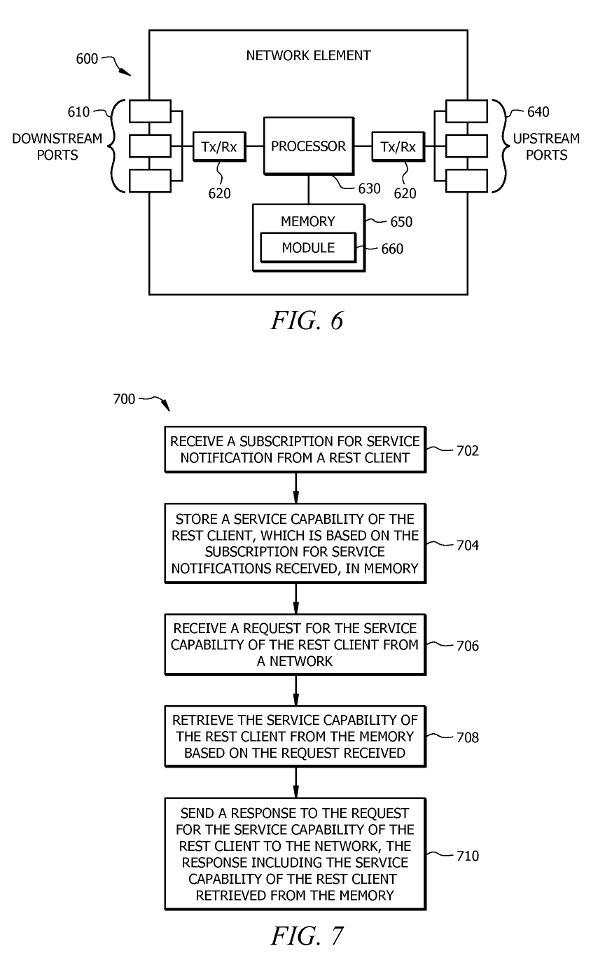

FIG. 6 is a schematic diagram of an embodiment of a server 600 used to send and receive messages or information through at least a portion of the system shown in FIGS. 4-5. At least some of the features/methods described in the disclosure may be implemented in the server 600. For instance, the features/methods of the disclosure may be implemented in hardware, firmware, and/or software installed to run on the hardware. The server 600 may be any device that transports data through a network, system, and/or domain. Moreover, the term server, computer, logic device, and/or similar terms may be interchangeably used to generally describe a server and do not have a particular or special meaning unless otherwise specifically stated and/or claimed within the disclosure.

In one embodiment, the server 600 may be an apparatus configured to participate in the capability discovery notification process depicted in FIGS. 4-5. In addition, components or functions of the server 600 may be implemented in and/or integrated within the clients 402-502 (e.g., client A, client B), service API server 406-506, or devices in the IMS/RCS network 408-508 as described and illustrated in FIGS. 4-5.

The server 600 may comprise one or more downstream ports 610 coupled to a transceiver (Tx/Rx) 620, which may be transmitters, receivers, or combinations thereof. The Tx/Rx 620 may transmit and/or receive messages or information from other network devices (e.g., servers, etc.) via the downstream ports 610. Similarly, the server 600 may comprise another Tx/Rx 620 coupled to a plurality of upstream ports 640, wherein the Tx/Rx 620 may transmit and/or receive messages or information from other network devices via the upstream ports 640. The downstream ports 610 and/or the upstream ports 640 may include electrical and/or optical transmitting and/or receiving components.

A processor 630 may be coupled to the Tx/Rx 620 and may be configured to process the messages or information and/or determine which servers to send (e.g., transmit) the messages or information to. In an embodiment, the processor 630 may comprise one or more multi-core processors and/or memories 650, which may function as data stores, buffers, etc. The processor 630 may be implemented as a general processor or may be part of one or more application specific integrated circuits (ASICs), field-programmable gate arrays (FPGAs), and/or digital signal processors (DSPs). Although illustrated as a single processor, the processor 630 is not so limited and may comprise multiple processors. The processor 630 may be configured to the adaptive and dynamic allocation of media resources described herein.

FIG. 6 illustrates that a memory 650 may be coupled to the processor 630 and may be a non-transitory medium configured to store various types of data. Memory 650 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory 650 may be used to house the instructions for carrying out the various example embodiments described herein. In one example embodiment, the memory 650 may comprise a module 660. In an embodiment, the module 660 represents a capability discovery notification module disposed within the service API server 406-506 as shown in FIGS. 4-5. The module 660 is capable of implementing capability discovery notification and permitting the service API server 406, 506, the client 402, 502, and the IMS/RCS network 508 to exchange messages. In other words, the module 660 permits the service API server 406, 506, the client 402, 502, and the IMS/RCS network 408, 508 to communicate with each other regarding, for example, the service capability of the client 402, 502 (e.g., client A).

It is understood that by programming and/or loading executable instructions onto the server 600, at least one of the processor 630, the cache, and the long-term storage are changed, transforming the server 600 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume and may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

FIG. 7 is a flowchart of an embodiment of a capability discovery notification method 700. In an embodiment, the method 700 is implemented by processor 630. In an embodiment, the method 700 is initiated by a client using an application. The method 700 is implemented to inform the service API server 406, 506 of the service capabilities of the client 402, 502 with a subscription request alone, which eliminates the need for the service discovery capability message from the client 402, 502.

In block 702, a subscription for service notifications is received from a REST client. In an embodiment, the subscription for service notifications is in the form of an HTTP POST message (e.g., POST ChatNotificationSubscription). In an embodiment, the subscription for service notifications is for standalone messaging, chat, group chat, video chat, file transfer, content sharing, social presence information, IP voice call, best effort video call, geolocation exchange, network based blacklist, and capability exchange based, etc. In an embodiment, the service is a service offered in connection with RCS.

In block 704, a service capability of the REST client is stored in memory. The service capability of the REST client is based on the subscription for service notifications received. For example, if the service API server 406 of FIG. 4 receives a subscription for chat from the client 402, the service API server 406 creates or updates a record stored in, for example, a cache or a database to indicate that client 402 is capable of participating in a chat. In an embodiment, the service capability of the client 402 includes one or more of standalone messaging, chat, group chat, video chat, file transfer, content sharing, social presence information, IP voice call, best effort video call, geolocation exchange, network based blacklist, and capability exchange based, etc. In an embodiment, the capability of the client 402 corresponds to a service offered in connection with RCS. Thus, the service API server 406 is informed of the service capability of the client 402 without the client having to send a separate service capability message to the service API server 406. Therefore, a single step procedure (e.g., sending the subscription) replaces the two-step procedure (e.g., sending both the service capability message and the subscription). The service capability message is eliminated, which simplifies the capability discovery process and reduces the messaging between the client 402 and the service API server 406.

In block 706, a request for the service capability of the REST client is received from a network (e.g., the IMS/RCS network 408). In an embodiment, the request may be in the form of a SIP OPTIONS request or a SIP PUBLISH request. Although not illustrated in FIG. 4, the network 408 may receive the request from another client (e.g., mobile phone, tablet computer, etc.) in the form of a SIP OPTIONS request.

In block 708, the service capability of the REST client is retrieved from the memory based on the request received. In an embodiment, the service API server 406 of FIG. 4 retrieves the service capability of the client 402 from the memory based on the request received. In block 710, a response to the request for the service capability of the REST client is sent to the network. The response includes the service capability of the REST client retrieved from the memory. In an embodiment, the capability of the client 402 is chat and file transfer. In an embodiment, the response is in the form of a SIP OK message. The network 408 is then able to notify the requesting client of the service capability of the client 402.

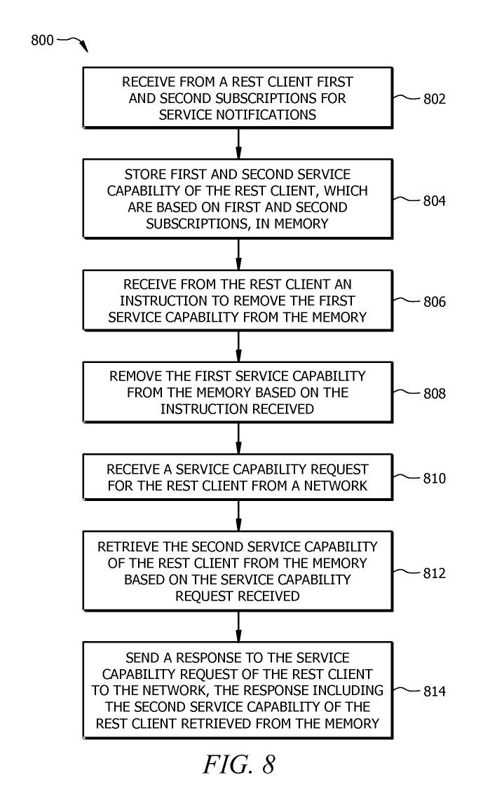

FIG. 8 is a flowchart of an embodiment of a capability discovery notification method 800. In an embodiment, the method 800 is implemented by processor 630. In an embodiment, the method 800 is initiated by a client using an application. The method 800 is implemented to inform the service API server 406, 506 of the service capabilities of the client 402, 502 with a subscription request alone, which eliminates the need for a service discovery capability message from the client 402, 502.

In block 802, a first subscription for service notifications and a second subscription for service notifications are received from a REST client. In an embodiment, the first subscription for service notifications is different than the second subscription for service notifications. For example, the first subscription is for chat and the second subscription is for file transfer. In an embodiment, the first subscription for service notifications is in the form of an HTTP POST message (e.g., POST ChatNotificationSubscription) and the second subscription for service notifications is in the form of an HTTP POST message (e.g., POST FileTransferNotificationSubscription).

In block 804, a first service capability of the REST client and a second service capability of the REST client are stored in memory. The first service capability of the REST client and the second service capability of the REST client are based on the first and second service notifications received. In an embodiment, the first service capability of the REST client is different than the second service capability of the REST client. For example, the first service capability is for chat and the second service capability is for file transfer. If the service API server 506 of FIG. 5 receives a subscription for chat from the client 502, the service API server 506 creates or updates a record stored in, for example, a cache or a database to indicate that client 502 is capable of participating in a chat. Likewise, if the service API server 506 of FIG. 5 receives a subscription for file transfer from the client 502, the service API server 506 creates or updates a record stored in, for example, a cache or a database to indicate that client 502 is capable of participating in a file transfer.

In block 806, an instruction to remove the first service capability of the REST client from the memory is received from the REST client. In an embodiment, the instruction is to remove the second service capability of the REST client from the memory instead of the first. In an embodiment, the client 502 of FIG. 5 requests that one of the previously-established subscriptions be terminated. In an embodiment, the delete message is in the form of an HTTP DELETE message (e.g., DELETE ChatNotificationSubscription).

In block 808, the first service capability of the REST client is removed from the memory based on the instruction received. In other words, the capability of the client 502 in FIG. 5 is updated or modified based on the delete message to reflect the current capabilities of the client 502.

In block 810, a service capability request for the REST client is received from the network. The request may be in the form of a SIP OPTIONS request or a SIP PUBLISH request. In an embodiment, the network 508 may receive the request from another client (e.g., mobile phone, tablet computer, etc.) in the form of a SIP OPTIONS request.

In block 812, the second service capability of the REST client is retrieved from the memory based on the service capability request received. In block 814, a response to the service capability request for the REST client is sent to the network. The response includes the second service capability of the REST client retrieved from the memory. In an embodiment, the response is in the form of a SIP OK message.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. A method of capability discovery notification, comprising:
receiving, from a representational state transfer (REST) client, a subscription for service notifications;
storing a service capability of the REST client in memory, wherein the service capability of the REST client is based on the subscription for service notifications received;
receiving, from a network, a request for the service capability of the REST client;
retrieving the service capability of the REST client from the memory based on the request received; and
sending, to the network, a response to the request for the service capability of the REST client, wherein the response includes the service capability of the REST client retrieved from the memory.

2. The method of claim 1, wherein the subscription for service notifications is packaged in a HTTP POST message.

3. The method of claim 1, wherein the subscription for service notifications is one of a standalone messaging, chat, group chat, video chat, file transfer, content sharing, social presence information, Internet Protocol (IP) voice call, best effort video call, geolocation exchange, network based blacklist, and capability exchange based subscription.

4. The method of claim 1, wherein the memory comprises at least one of a cache and a database.

5. The method of claim 1, wherein the network comprises an Internet Protocol (IP) multimedia system (IMS)/Rich Communications Services (RCS) network.

6. The method of claim 1, wherein the service capability of the REST client is one of a standalone messaging, chat, group chat, video chat, file transfer, content sharing, social presence information, Internet Protocol (IP) voice call, best effort video call, geolocation exchange, network based blacklist, and capability exchange based capability.

7. The method of claim 1, wherein the request for the service capability of the REST client is packaged in a session initiation protocol (SIP) OPTIONS message.

8. The method of claim 1, wherein the request for the service capability of the REST client is packaged in a session initiation protocol (SIP) PUBLISH message.

9. The method of claim 1, wherein the response to the request for the service capability of the REST client is packaged in a session initiation protocol (SIP) OK message.

10. The method of claim 1, wherein the network received the request for the service capability of the REST client from a target device, and wherein the target device is a mobile phone.

11. A method of capability discovery notification, comprising:
receiving, from a representational state transfer (REST) client, a first subscription for service notifications and a second subscription for service notifications, wherein the first subscription for service notifications is different than the second subscription for service notifications;
storing a first service capability of the REST client and a second service capability of the REST client in memory, wherein the first service capability of the REST client and the second service capability of the REST client are based on the first and second service notifications received, and wherein the first service capability of the REST client is different than the second service capability of the REST client;
receiving, from the representational state transfer (REST) client, an instruction to remove the first service capability of the REST client from the memory;
removing the first service capability of the REST client from the memory based on the instruction received;
receiving, from a network, a service capability request for the REST client;
retrieving the second service capability of the REST client from the memory based on the service capability request received; and
sending, to the network, a response to the service capability request for the REST client, the response including the second service capability of the REST client retrieved from the memory.

12. The method of claim 11, wherein the first subscription for service notifications is a chat notification subscription and the second subscription for service notifications is a file transfer notification subscription.

13. The method of claim 11, wherein the first service capability of the REST client is a chat capability and the second service capability of the REST client is a file transfer capability.

14. The method of claim 11, wherein the first service capability of the REST client is a file transfer capability and the second service capability of the REST client is a chat capability.

15. The method of claim 11, wherein the instruction to remove the first service capability of the REST client from the memory is packaged in a Hypertext Transfer Protocol (HTTP) DELETE message, and wherein the service capability request for the REST client is packaged in one of a session initiation protocol (SIP) OPTIONS message and a SIP PUBLISH message.

16. The method of claim 11, wherein the response to the service capability request for the REST client is packaged in a session initiation protocol (SIP) OK message.

17. The method of claim 11, wherein the network received the request for the service capability of the REST client from a target device, and wherein the target device is a mobile phone.

18. A service application server, comprising:
a processor operably coupled to a memory; and
a service capability module stored in the memory that, when executed by the processor, is configured to:
receive, from a representational state transfer (REST) client, a plurality of subscriptions for service notifications;
store service capabilities of the REST client in memory, wherein the service capabilities of the REST client are based on the plurality of subscriptions for service notifications received;
receive, from the REST client, an instruction to remove at least one of the plurality of subscriptions for service notifications from the memory;
update the memory based on the instruction such that the memory contains a current indication of the service capabilities of the REST client; and
send, to a network, the current indication of the service capabilities of the REST client when a request for the service capabilities of the REST client is received from the network.

19. The service application server of claim 18, wherein the instruction is packaged in a Hypertext Transfer Protocol (HTTP) DELETE message, and the current indication of the service capabilities of the REST client sent to the network is packaged in a session initiation protocol (SIP) OK message.

20. The service application server of claim 19, wherein the request for the service capabilities of the REST client is packaged in a SIP OPTIONS message originating from a target client, and wherein the target client is a mobile phone.
